(19) United States
(12) Patent Application Publication
(10) Pub. No.: US 2026/0255323 A1
(43) Pub. Date: Aug. 27, 2026

(54) USER EQUIPMENT AND METHOD FOR RESOURCE ALLOCATION AND INDICATION IN SIDELINK COMMUNICATION

(71) Applicant: GUANGDONG OPPO MOBILE TELECOMMUNICATIONS CORP., LTD., Dongguan (CN)

(72) Inventor: Huei-Ming LIN, Taipei (TW)

(73) Assignee: GUANGDONG OPPO MOBILE TELECOMMUNICATIONS CORP., LTD., Dongguan (CN)

(21) Appl. No.: 19/652,017

(22) Filed: Apr. 20, 2026

Related U.S. Application Data
(63) Continuation of application No. PCT/CN2023/126404, filed on Oct. 25, 2023.

(51) Int. Cl. H04W 72/02; H04W 72/40; H04W 72/542

(52) U.S. Cl. CPC H04W 72/02; H04W 72/40; H04W 72/542

(57) ABSTRACT

Provided in the present application are a method for resource allocation and indication in sidelink (SL) communication by a user equipment (UE), a UE and a chip. The method includes selecting, by the UE, SL resources for SL transmission across multiple resource pools (RPs)/carriers, the multiple RPs/carriers includes a first RP on a first SL carrier and a second RP on a second SL carrier, and indicating, by the UE, selected SL resources across the multiple RPs/carriers for assignment and reservation during the SL transmission.

### CROSS-REFERENCE TO RELATED APPLICATION

This application is a continuation of International Application No. PCT/CN2023/126404 filed on Oct. 25, 2023, the disclosure of which is hereby incorporated by reference in its entirety.

### BACKGROUND

In the advancement of radio wireless transmission and reception directly between two devices, which is often known as device-to-device (D2D) communication, it is first developed by 3rd generation partnership project (3GPP) and introduced in Release 12 (officially specified as sidelink communication) and improved in Release 13 for public safety emergency usage such as mission critical communication to support mainly low data rate and voice type of connection. In 3GPP Releases 14, 15, and 16, the sidelink technology is advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology is further enhanced in Release 17 in power saving and transceiver link reliability. In Release 18, 3GPP further evolved the wireless technology and expanded its operation into unlicensed frequency spectrum. This is for larger available bandwidth, faster data transfer rate, and easier market adoption of D2D communication using sidelink without requiring any mobile cellular operator's involvement to allocate and configure a part of their expansive precious radio spectrum for data services that do not go throughput their mobile networks. To further expand the operating bandwidth of D2D communication and to be able to utilize the sidelink technology for wider range of application and deployment scenarios (e.g., fragmented frequency spectrum allocation in wireless communication), 3GPP is currently looking to enable a multi-carrier operation for the future releases of the sidelink technology.

Therefore, there is a need for a user equipment (UE) and a method for resource allocation and indication between user equipments (UEs) in sidelink (SL) communication, which can solve issues in the prior art and other issues.

### SUMMARY

The present disclosure relates to the field of communication systems, and more particularly, to a user equipment (UE) and a method for resource allocation and indication between user equipments (UEs) in sidelink (SL) communication, which can provide a good communication performance and/or provide high reliability.

In a first aspect of the present disclosure, a method for resource allocation and indication in sidelink (SL) communication by a user equipment (UE) includes selecting, by the UE, SL resources for SL transmission across multiple resource pools (RPs)/carriers, wherein the multiple RPs/carriers include a first RP on a first SL carrier and a second RP on a second SL carrier, and indicating, by the UE, selected SL resources across the multiple RPs/carriers for assignment and reservation during the SL transmission.

In a second aspect of the present disclosure, a user equipment (UE) includes a memory, and a processor, the memory stores a computer program that, when executed by the processor, causes the processor to perform the above method.

In a third aspect of the present disclosure, a chip includes a processor, configured to call and run a computer program stored in a memory, to cause a device in which the chip is installed to execute the above method.

### BRIEF DESCRIPTION OF THE DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a method for resource allocation and indication between user equipments (UEs) in sidelink (SL) communication according to an embodiment of the present disclosure.

FIG. 5 is a schematic diagram illustrating a proposed sidelink (SL) sensing and resource assignment/reservation in a SL multi-carrier operation with a supplementary SL resource pool/carrier according to an embodiment of the present disclosure.

FIG. 6 is a schematic diagram illustrating a proposed cross-carrier resource assignment/reservation indication in a SL multi-carrier operation according to an embodiment of the present disclosure.

FIG. 7 is a block diagram of a UE for wireless communication according to an embodiment of the present disclosure.

FIG. 8 is a block diagram of an example of a computing device according to an embodiment of the present disclosure.

FIG. 9 is a block diagram of a system for wireless communication according to an embodiment of the present disclosure.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

For future releases of sidelink technology, one potential and promising technical feature is to support sidelink (SL) communication with simultaneous transmission (TX) and reception (RX) on multiple carriers and/or resource pools. This can further enhance a throughput data rate (via carrier aggregation, CA), in an assistance manner (one carrier assisting another carrier) and repeat data packets on multiple carriers to further enhance communication reliability (via packet duplication).

### Mode 2 Resource Allocation Mechanism in Sidelink

In the existing design of resource allocation mechanism for SL communication, a Mode 2 resource selection method relies on a SL transmitting UE to perform autonomous selection of resources on its own from a pool of SL resources for transmission of data packets. In this resource allocation mode, the selection of transmission resources is not random at the start but based on a sensing and reservation strategy to avoid collision with other SL transmission UEs operating in the same resource pool. In this resource selection strategy, a transmitting UE senses the channel for a period of a sensing window to decode and detect information about reservation of SL resources from other transmitting/surrounding UEs. Based on detected resource reservation information, the transmitting UE excludes resources that are already reserved from selection to avoid transmission collision and selects a number of required resources from the remaining/available (non-reserved) ones randomly for its own transmission(s). During the transmissions using the selected resources, likewise, the transmitting UE also sends out/broadcasts its own resource reservation information in the resource pool using sidelink control information (SCI) messages so that other UEs may also avoid collision by not selecting the same or an overlap resource. In the existing resource indication and reservation signaling design, a time gap between two consecutive resources for reservation can be up to 31 slots apart within the same SL resource pool.

### Multi-Carrier SL Operation

During the early development of the new radio (NR) sidelink technology in 3rd generation partnership project (3GPP), SL communication is supported on only a single carrier for both TX and RX in a single band. That is, it is not required for a SL UE to perform carrier switching (RF retuning) in order to transmit data to other SL UEs and/or receive data from other SL UEs. This assumption/support for SL operation has some drawbacks such as limited data rate support, not being able to support concurrent SL operation on more than one carrier unless an additional sidelink TX/RX module is implemented, resource selection and reception conflicts, and etc. In order to mitigate this issue (to a certain extend), SL multi-carrier operation (termed SL carrier aggregation, SL-CA) based on a very limited set of functionalities is introduced in Release 18 for supporting V2X operation in an intelligent transportation system (ITS) band only with fragmented spectrum allocation, where SL-CA supports only Mode 2 resource allocation (without network intervention), per-carrier operation for both control, data and feedback reporting, and assumes a same sub-carrier spacing (SCS) among all aggregating SL carriers and no consideration of limited transmission and reception capability. With these restrictions, although it may be sufficient for V2X services, the SL-CA feature is not well suited for commercial network operation and public safety uses.

### Limited UE Capability in TX and/or RX

Besides electrical plug-in terminals, tablets, and smartphones with a decent size of battery, there are currently a few other types of portable communication device with restricted size and constrained form factor that can only equipe with limited battery power to support applications with high processing demand such as glasses, watches, headphones, wrist bands and even bike helmets for vehicle-to-pedestrian (V2P) communication. For these power constrained devices, often due to its size and cost of running, practically they would be also restricted in terms of its wireless transmission (TX) and reception (RX) capabilities. For example, devices operating with 1TX/1RX antenna, lower bandwidth (BW) support, lower peak data rate, and reduced active time in wireless transceiver operation to conserve power. In SL communication, the support for these devices with limited/reduced capabilities (SL RedCap UEs) has been very limited. In 3GPP Release 17, power saving features such as partial sensing and resource ransom selection are supported. However, devices with limited TX and RX capability are not well supported so far for the NR sidelink technology.

In some embodiments, in some exemplary resource allocation and indication methods for SL communication in multiple SL carriers/resource pools, UE jointly selects resources for its transmissions from multiple RPs/carriers in a UE autonomous resource allocation procedure based on sensing results obtained from one, a subset or the full set of the multiple RPs/carriers, and jointly indicates the selected resources in sidelink control information (SCI) for improved performance and reliability. Other benefits from using the proposed exemplary resource allocation and indication methods also include at least one of the followings: 1. Reduce a transmission collision probability based on a cross-RP/carrier indication. 2. Avoid a resource selection conflict within a UE for already selected resources and potential transmissions. 3. Avoid dropping of SL transmissions due to a required RF retuning time for inter-band multi-carrier SL operation. 4. Avoid mis-detection of physical sidelink feedback channel (PSFCH) feedback transmissions due to limited reception capability of the UE. 5. In some scenarios, some exemplary methods create more indications/reservation for a selected resource, and thus can improve/minimize the half-duplex problem when another UE transmits and cannot receive one of the indications. 6. In some scenarios, some exemplary methods reduce processing power consumption for a SL CA receiver UE to monitor SCI in one RP/carrier only. 7. Reduced SCI signaling in RPs configured with no physical sidelink control channel (PSCCH) resources would provide more frequency resources for the actual data transmission for improved performance and higher data rate. 8. Reduced SCI signaling also means less SCI monitoring for the receiver UEs, especially for SL RedCap UEs to improve/minimize processing power in both RF and baseband. 9. In some cases, the cross-RP/carrier resource assignment/reservation indication improves the reliability of SL transmissions in a fast fading channel when one of carrier is in a deep fade condition.

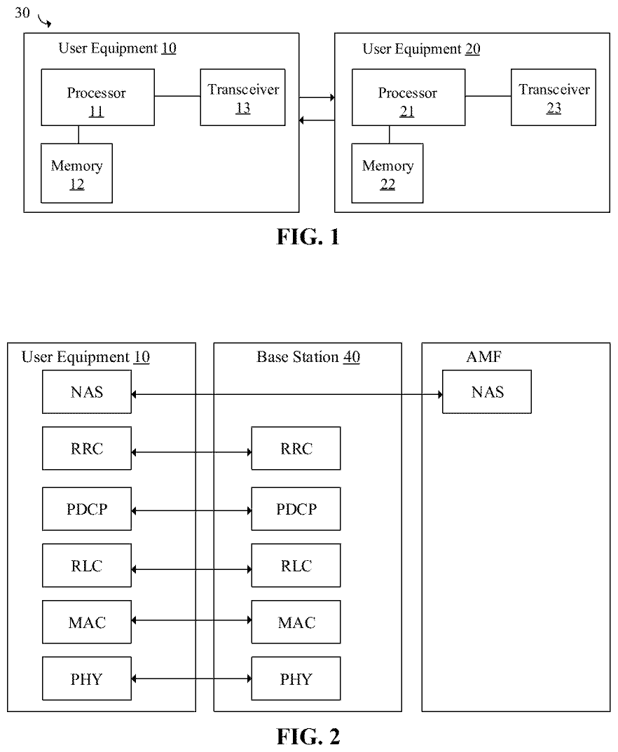

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR releases 18 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

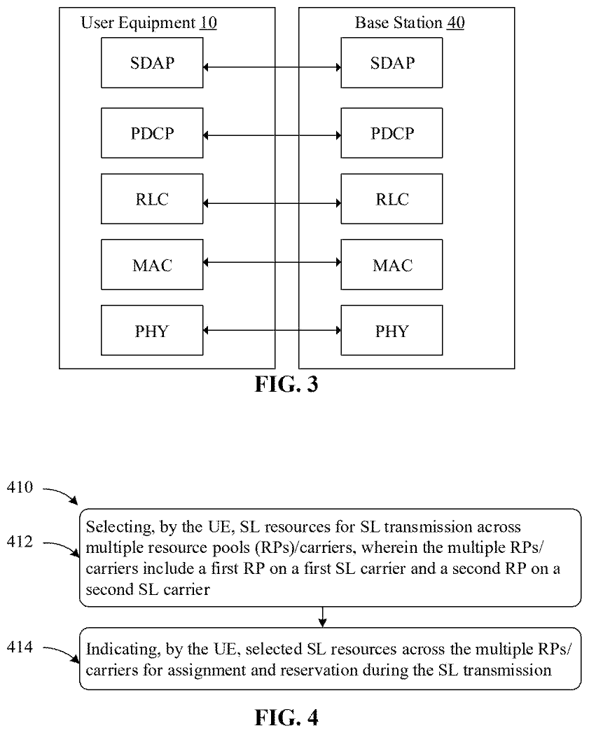

FIG. 3 illustrates an example control plane protocol stack according to an embodiment of the present disclosure. FIG. 3 illustrates that, in some embodiments, in the control plane protocol stack where PDCP, RLC, and MAC layers and PHY layer may be terminated in a UE 10 and a base station 40 (such as gNB) on a network side and perform service and functions described above. In an example, radio resource control (RRC) used to control a radio resource between the UE and a base station (such as a gNB). In an example, RRC may be terminated in a UE and the gNB on a network side. In an example, services and functions of RRC may comprise broadcast of system information related to access stratum (AS) and non-access stratum (NAS), paging initiated by 5G core network (5GC) or radio access network (RAN), establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an access and mobility management function (AMF) for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. (Alternatively, the application-related information is received from the network to be provided from the AS (RRC) layer to the application layer, and when the application layer starts the data communication service, the application layer requests the information provision to the AS (RRC) layer to receive the information.)

In some embodiments, the processor 11 is configured to select SL resources for SL transmission across multiple resource pools (RPs)/carriers, wherein the multiple RPs/carriers include a first RP on a first SL carrier and a second RP on a second SL carrier, and the processor 11 is configured to indicate selected SL resources across the multiple RPs/carriers for assignment and reservation during the SL transmission. This can solve issues in the prior art and other others, and/or improve SL communication performance and reliability.

FIG. 4 illustrates a method 410 for resource allocation and indication between user equipments (UEs) in sidelink (SL) communication according to an embodiment of the present disclosure. In some embodiments, the method 410 includes: an operation 412, selecting, by the UE, SL resources for SL transmission across multiple resource pools (RPs)/carriers, wherein the multiple RPs/carriers include a first RP on a first SL carrier and a second RP on a second SL carrier, and an operation 414, indicating, by the UE, selected SL resources across the multiple RPs/carriers for assignment and reservation during the SL transmission. This can solve issues in the prior art and other others, and/or improve SL communication performance and reliability.

In some embodiments, the method further includes performing sensing, by the UE, on one or more RPs and/or carriers over a common sensing window to obtain sensing results, wherein selecting the SL resources for SL transmission across the multiple RPs/carriers is based on the sensing results. In some embodiments, the one or more RPs and/or carriers is one, a subset, or a full set of the multiple SL RPs/carriers, or the one or more RPs and/or carriers is the multiple RPs/carriers. In some embodiments, the method further includes excluding or avoiding selecting, by the UE, overlapping candidate resources from the multiple RPs/carriers based on the sensing results. In some embodiments, the method further includes triggering, by at least one higher layer of the UE, a UE autonomous resource allocation by providing one or more parameters to a first layer of the UE for reporting a subset of candidate resources per RP/carrier to the at least one higher layer after excluding or avoiding selecting the overlapping candidate resources. In some embodiments, excluding or avoiding selecting the overlapping candidate resources is based on a SL reference signal received power (SL-RSRP) and/or a SL-RSRP threshold level.

In some embodiments, the SL-RSRP and/or the SL-RSRP threshold level is determined based on a priority level of the SL transmission and/or a priority level in a sidelink control information (SCI). In some embodiments, excluding or avoiding selecting the overlapping candidate resources is based on a limitation of number of simultaneous transmissions supported by the UE over the multiple carriers/RPs. In some embodiments, excluding or avoiding selecting the overlapping candidate resources is based on one or more carrier combinations and/or an interruption due to radio frequency (RF) retuning time. In some embodiments, excluding or avoiding selecting the overlapping candidate resources is based on a physical sidelink feedback channel (PSFCH) reception timing/slot. In some embodiments, for reporting the subset of candidate resources per RP/carrier to the at least one higher layer, if a remaining number of candidate resources for one RP/carrier is less than a first percentage of a full set of candidate resources for the one RP/carrier, the SL-RSRP threshold level is increased by a first value for each priority level, and excluding or avoiding selecting the overlapping candidate resources is re-performed from the full set of candidate resources for the one RP/carrier.

In some embodiments, for reporting the subset of candidate resources per RP/carrier to the at least one higher layer, if remaining candidate resources across the multiple RPs/carriers is less than a first percentage of a combined number of a full set of candidate resources of each RP/carrier, the SL-RSRP threshold level is increased by a first value for each priority level, and excluding or avoiding selecting the overlapping candidate resources is re-performed from the full set of candidate resources for every RP/carrier. In some embodiments, selecting the SL resources for SL transmission across the multiple RPs/carriers includes selecting, by the at least one higher layer of the UE, the SL resources for SL transmission from the reported candidate resource sets of the multiple RPs/carriers based on a time gap not more than 31 slots between any two or three consecutive selected resources. In some embodiments, a time gap between two selected consecutive resources on the same RP/carrier is more than 31 slots if a cross-RP/carrier resource assignment/reservation is allowed for the UE and/or intended by the UE. In some embodiments, if one RP/carrier is configured with PSFCH resources, a minimum time gap is between any two consecutive selected resources within the one RP/carrier.

In some embodiments, indicating the selected SL resources across the multiple RPs/carriers for assignment and reservation during the SL transmission includes: a carrier index and/or a RP index is provided per SL resource indicated in frequency and time resource assignment fields of a first stage SCI. In some embodiments, indicating the selected SL resources across the multiple RPs/carriers for assignment and reservation during the SL transmission includes at least one additional set of SL resources along with a carrier index and/or a RP index is provided in the first stage SCI or a second stage SCI for assigning/reserving SL resources in another RP/carrier. In some embodiments, indicating the selected SL resources across the multiple RPs/carriers for assignment and reservation during the SL transmission includes a carrier index and/or a RP index is indicated per assigned/reserved SL resource and per set of up to 3 SL resources. In some embodiments, a first set of up to 3 SL resources along with a carrier index and/or a RP index per SL resource is indicated in the first stage SCI.

In some embodiments, at least one additional set of SL resources along with a carrier index and/or a RP index is indicated in the first stage SCI or the second stage SCI. In some embodiments, the carrier index and/or the RP index is provided to the UE by a network configuration or a pre-configuration, at least one higher layer, or a PC5 radio resource control (PC5-RRC) signaling from another UE. In some embodiments, the carrier index and/or the RP index for SL broadcast transmission is provided to the UE by the network configuration or the pre-configuration, the carrier index and/or the RP index for SL groupcast transmission is provided to the UE by the at least one higher layer, or the carrier index and/or the RP index for SL unicast transmission is provided to the UE by the network configuration or the pre-configuration. In some embodiments, different sets of SL resources are associated with different transport blocks (TBs) or the same TB.

In some embodiments, the term “/” can be interpreted to indicate “and/or.” The term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

### Examples

In the existing/current version of 3GPP new radio (NR) sidelink (SL) technology for the direct D2D wireless communication, it is a basic assumption that a user equipment (UE) only operates in a single frequency carrier for both SL transmission (TX) and reception (RX) of synchronization signaling, control and feedback reporting information, and data messages. When a UE operates in SL resource allocation Mode 2, the UE autonomously selects resources from a SL resource pool (RP) in a SL frequency carrier based on sensing and reservation information to avoid transmission collision with others. Hence, the existing SL communication mechanism is a “per-carrier” based operation. When a UE supports and operates simultaneously on more than one carrier for different SL services (e.g., one carrier for cellular vehicle-to-everything (C-V2X) communication and another carrier for interactive gaming application with another UE), SL communication for these services operates independently on each carrier without any interaction.

However, this “per-carrier” independent operation may create issues in SL resource selection conflict due to limited UE capability in number of supported TX/RX radio frequency (RF) components and processing chains. For example, when a UE supports only one TX RF antenna and processing chain, and it selects two SL resources for simultaneous transmission in a same slot but on two different carriers, this situation creates a transmission conflict within the UE itself and one of the selected transmissions would have to be dropped eventually and trigger a resource re-selection for the dropped transmission (causing longer delay in delivering the data message). This could be particularly harmful if the dropped transmission contains a high priority data packet(s).

Similarly, if the UE is capable of receiving SL on only one carrier at a time but two SL-hybrid automatic repeat request (SL-HARQ) feedback reports are due to be received in physical sidelink feedback channel (PSFCH) at the same time (in the same slot and symbol timing) but on different carriers, a conflict in the SL reception may also occur for the UE. When an acknowledgement (ACK) feedback in SL-HARQ is not received by the UE, it triggers the UE to perform a redundant retransmission of the same data packet(s), and thus wasting transmission power for the UE, takes away a transmission opportunity for another data packet (and longer delay), and creates a higher traffic congestion on the frequency carrier (less available resources for other UEs).

Furthermore, the “per-carrier” operation in SL communication also creates limitation in the maximum supported data rate for a SL service since there is only one carrier. When two or more carriers are configured to deliver user data packets, the multiple carriers can be used by the UE to transmit different user information to increase data throughput by the number of carriers, or the multiple carriers can be used for transmitting duplicated data on different carriers to improve delivery reliability (to mitigate the fast-fading effect on one of the carriers). Therefore, it is beneficial to support multi-carrier operations in SL resource allocation to resolve the UE capability limitation issues in resource selection and the half-duplex problem, while maximizing the data throughput or transmission reliability.

In another scenario, when a SL UE device with reduced or limited wireless transmission, reception or processing capability (referred hereafter as a RedCap UE) is communicating with other “full capability” UEs in a SL multi-carrier operation (i.e., UEs without restricted/limited capability or UEs with higher capability), based on the current “per-carrier” operation, it is required for the RedCap UE to monitor sidelink control information (SCI) across the multiple carriers at all times (every slot) for both resource indication and data reception. The SL reception and blind decoding of SCI can be very power consuming for a UE device and wasteful when there is no data transmitted and intended for the RedCap UE, or when the RedCap UE is not performing resource selection in some of the carriers.

In order to resolve the aforementioned resource conflict problem for a UE with limited capability operating SL communication over multiple carriers concurrently and performing individual TX and RX functions independently on each carrier, in some exemplary resource selection and indication methods, it is proposed to jointly select resources from multiple SL RPs or carriers based on sensing and reservation information from just one or a subset of the multiple RPs/carriers, and jointly indicate the selected resources from the multiple RPs/carriers in SCI for reservation.

In some embodiments of the present disclosure, for a UE to perform SL transmissions using a set of multiple resource pools on multiple carriers provided by a higher layer (multi-carrier operation), where one carrier and its associated SL BWP is configured with at least one SL resource pool (RP), the UE jointly selects resources from the provided set of multiple RPs/carriers based on sensing results obtained from one, a subset or the full set of the provided multiple RPs/carriers for SL transmissions. Therefore, the resource selection and the usage of the selected resources from the multiple RPs is equivalent to SL transmissions over the multiple frequency carriers. The sensing results obtained from the one, a subset or the full set of the provided multiple RPs/carriers include resource assignment/reservation information for the provided multiple SL RPs/carriers carried in sidelink control information (SCI), and SL-RSRP measurement of the received SCI. In order to trigger a UE autonomous resource selection procedure, the higher layer (e.g., medium access control (MAC) layer) provides one or more of the following information to L1 (i.e., physical layer of the UE) for reporting a set of available candidate resources per configured/indicated RP after resource exclusion that can be used by the higher layer for selecting resources for PSCCH/PSSCH transmission using the provided set of multiple RPs on multiple carriers.

The one or more of the following information may include:

1. A set of multiple carriers and/or the associated resource pools for reporting subsets of candidate resources. Let's denote this set of RPs/carriers for candidate resources reporting to the higher layer for resource selection in the higher layer and subsequently SL transmissions as Set_{TX}.

2. A set of one or more resource pools and/or carriers for SL sensing, where the set (denoted as Set_{sensing}) is a subset or the full set of the set of RPs/carriers for reporting subsets of candidate resources (Set_{TX}).

3. Priority level of the SL transmission, prio_{TX}.

4. Remaining packet delay budget of the data transport block (TB) or MAC protocol data unit (MAC PDU) to be transmitted.

5. Number of sub-channels to be used for the SL transmission, L_{subCH}.

6. Resource reservation interval for the SL transmission, P_{rsvp_TX}.

The UE performs sensing on the provided one or more resource pools and/or carriers for SL sensing (Set_{sensing}) over a common sensing window (i.e., the same sensing window starting and ending time slots/positions are used for the one or more resource pools/carriers Set_{sensing}) to obtain sensing results for the provided multiple resource pools/carrier (Set_{TX}). When one of the RPs/carriers of the set (Set_{sensing}) is associated with more than one RP/carrier of the set (Set_{TX}). The benefit of using just one or a subset of transmission RPs/carriers for SL sensing is to reduce the amount of sensing effort for UEs with reduced/limited processing or reception capability. For example, when a UE is capable of simultaneous transmissions on two carriers, but it is limited in reception on only one carrier for sensing, the UE could perform SL sensing on just the one RP/carrier to obtain resource assignments/reservations information on both TX carriers. In a such case, one of the two TX RPs/carriers could be configured as a supplementary SL RP/carrier to other SL RP/carrier, where resource assignments/reservations are (always) associated with the other carrier.

When the set of one or more RPs/carriers for SL sensing is not provided by the higher layer (i.e., no Set_{sensing}), the UE performs SL sensing over the provided set of RPs/carriers for reporting subsets of available candidate resources (Set_{TX}). In a such case, the same common sensing window applies to entire set of provided RPs/carriers (Set_{TX}).

The UE then, based on the obtained sensing results, exclude any overlapping candidate resource from the provided set of multiple carriers/resource pools for reporting subsets of candidate resources (Set_{TX}).

In one example, the resource exclusion is based on the measured SL reference signal received power (SL-RSRP) and a SL-RSRP threshold level which are determined based on the priority level of the SL transmission (prio_{TX}) and indicated priority level in the received SCI during sensing (prio_{RX}).

In another example, resource exclusion of a candidate resource in a RP/carrier is further based the limitation of number of simultaneous transmissions supported by the UE over the multiple carriers/RPs, under the assumption that transmissions take place in other RP(s)/carrier(s) using the already selected resources and/or any potential transmission. When a UE supports simultaneous SL transmissions on two carriers and it already has a selected resource for transmission in a slot of a carrier, then the UE excludes or avoids selecting resources in all carriers but one in that particular slot for resource selection.

In one more example, the resource exclusion also includes the supported carrier combination(s) or interruption due to RF retuning time. If the RF retuning time from one carrier to another carrier takes one slot length (e.g., when the two RPs or carriers are in different frequency spectrum bands; inter-band retuning/switching for the UE), the UE excludes or avoids all resources in slots that are within the RF retuning time for selection.

In one further example, due to limited RX capability of the UE in receiving PSFCH feedbacks over multiple RPs/carriers, the resource exclusion or avoidance of selecting resources for SL transmissions is based on a PSFCH reception timing such that the UE is not required to receive PSFCH feedback in a number of RPs/carriers that is more than its RX capability for simultaneous reception.

Before the reporting of subset of available candidate resources to the higher layer, in one example, if the remaining number of available candidate resources is less than X % of the full set of candidate resources for a SL RP/carrier, the SL-RSRP threshold level is increased by 3 dB for each priority level, and the resource exclusion is re-performed from the full set of candidate resources for the SL RP/carrier. This process is repeated until the X % is fulfilled for the resource pool.

In another example, if the remaining number of candidate resources across all provided SL RPs/carriers is less than X % of the combined number of the full set of candidate resources of each SL RP/carrier, the SL-RSRP threshold level is increased by 3 dB for each priority level, and the resource exclusion is re-performed from the full set of candidate resources for every configured/indicated SL RP/carrier. This process is repeated until the X % is fulfilled.

Once the X % criteria is fulfilled, the UE reports the remaining set of candidate resources for each SL RP/carrier to the higher layer. The higher layer selects a set of resources from the reported candidate resource set of each resource pool for SL transmission on one or multiple SL RPs/carriers. The resource selection in the higher layer from the reported candidate resource sets of the multiple SL RPs/carriers (Set_{TX}) can ensure a time gap of not more than 31 slots between any two or three consecutive selected resources. The time gap between two selected consecutive resources on the same RP/carrier can be more than 31 slots if cross-RP/carrier resource assignment/reservation is allowed for the UE and/or intended by the UE. If a SL RP/carrier is configured with PSFCH resources, a minimum time gap can be also ensured between any two consecutive selected resources within the SL RP/carrier.

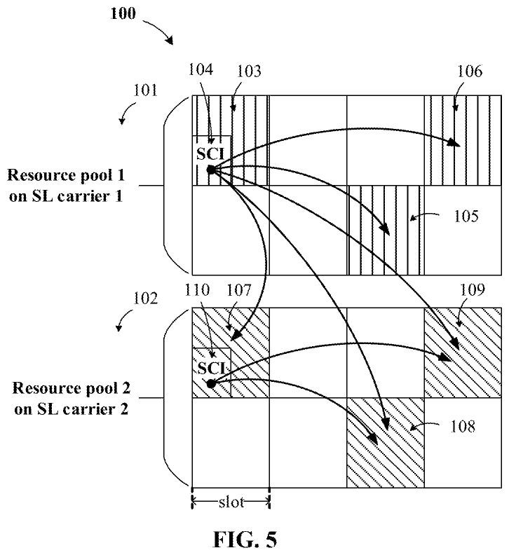

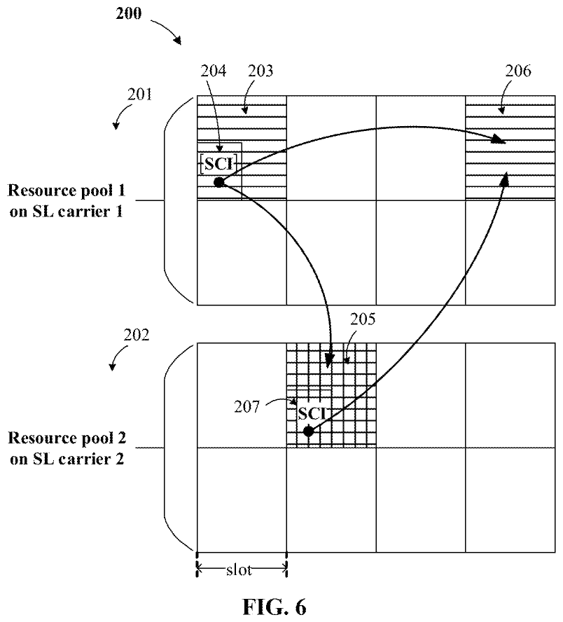

FIG. 5 illustrates a proposed sidelink (SL) sensing and resource assignment/reservation in a SL multi-carrier operation with a supplementary SL resource pool/carrier according to an embodiment of the present disclosure. In reference to Diagram 100 of FIG. 5, an exemplary illustration of the proposed SL sensing and resource assignment/reservation of a supplementary SL resource pool/carrier in a SL multi-carrier operation is illustrated. For a UE that is configured for SL multi-carrier operation and triggered for UE autonomous resource selection by a higher layer, UE L1 is firstly provided with a set of multiple RPs/carriers (Set_{TX}) including a RP_1 on SL carrier 1 101 and a RP_2 on SL carrier 2 102 for reporting a subset of candidate resources (available resources) for each RP/carrier. For the illustrated example here, the L1 is further provided with a set of one RP/carrier for SL sensing (Set_{sensing}), including just RP_1 on SL carrier 1 101, for the triggered candidate resource reporting. In this case, the UE performs SL sensing only on RP_1 on SL carrier 1 101 to obtained resource assignment/reservation information sent by other UEs and intended for both RP_1 on SL carrier 1 101 and RP_2 on SL carrier 2 102.

In the illustrated example here, the UE performs SL sensing on RP_1 on SL carrier 1 101 only. In SL resource 103, the UE receives and decodes a transmitted SCI 104. Based on the resource assignment/reservation information carried in the SCI 104, the UE understands that SL resources 103, 105, and 106 on RP_1 on SL carrier 1 101 are reserved, and hence, are excluded from the candidate resources set for RP_1 on SL carrier 1 101 before the reporting of a subset to the higher layer. From the received SCI 104, the resource assignment/reservation information additionally includes a reservation indication also intended for the RP_2 on SL carrier 2 102. This means a mirror set of SL resources 107, 108, and 109 in RP_2 on SL carrier 2 102 are also reserved by the received SCI 104. As such, the UE excludes the mirror set of SL resources 107, 108, and 109 from the candidate resources set for RP_2 on SL carrier 2 102 before the reporting of a subset to the higher layer. As part of the SL transmission in resource 107, an SCI 110 is also sent in RP_2 on SL carrier 2 102 for reserving SL resources 107, 108, and 109. As such, for another UE operating and performing SL sensing only on RP_2 on SL carrier 2 102, the another UE obtains the same resource assignment/reservation information for SL resources 107, 108, and 109 and excludes the SL resources from its selection to avoid resource conflict.

In some examples, the concept of supplementary SL RP/carrier is to add-on or to associate a SL resource pool/carrier to another SL resource pool/carrier, where the resource assignment/reservation information for the supplementary SL RP/carrier can be obtained from the another SL RP/carrier such that a UE only needs to sense/monitor SCI sent on the another SL RP/carrier to obtain resource assignment/reservation information for both RPs/carriers and subsequently reduce the amount of SCI processing and SL-RSRP measurement. This is also particularly beneficial for UEs with reduced/limited RX capability.

In some embodiments of the proposed methods of resource selection and indication for SL communication using a set of resource pools on multiple SL carriers, as illustrated in FIG. 5, a cross-RP/carrier resource assignment/reservation indication is proposed to be included in SCI for assigning/reserving SL resources in a RP/carrier that is different from the RP/carrier in which the SCI is transmitted. In some embodiments, the main purpose of using the cross-RP/carrier resource assignment/reservation indication is to assist a RedCap UE with a limited RX capability to obtain resource assignment/reservation information for multiple RPs/carriers from monitoring SCIs on just one or a subset of the multiple RPs/carriers. By doing so, the RedCap UE would be able to determine the timing in which it needs to switch the radio frequency receiving chain to another RP/carrier to receive data from another UE, and at the same time be able to also exclude reserved resources on the another RP/carrier for transmission during the resource allocation process.

Other benefits of using the proposed cross-RP/carrier resource assignment/reservation indication (instead of using the existing per-RP/carrier indication method) also include one of the followings.

1. Reduced SCI signaling in RPs configured with no physical sidelink control channel (PSCCH) resources (e.g., a data only RP, supplementary SL RP/carrier) would provide more frequency resources to be used for the actual data transmission in physical sidelink shared channel (PSSCH) for improved performance and higher data rate.

2. Reduced SCI signaling also means less SCI monitoring for the receiver UEs, especially for SL RedCap UEs to minimize processing power in both RF and baseband.

3. In some cases, the cross-RP/carrier resource assignment/reservation indication improves the reliability of SL transmissions in a fast fading channel when one of carrier is in a deep fade condition.

In cross-RP/carrier indication of selected resource(s) for resource assignment/reservation from one RP/carrier to another one or more RPs/carriers, in one example (Method 1), a carrier index or a RP index is provided per SL resource indicated in the frequency and time resource assignment fields of the 1^{st} stage SCI, except for the first SL resource in which the SCI is transmitted. Since a maximum number of 3 SL resources can be indicated by the frequency and time resource assignment fields in SCI (including the SL resource in which the SCI is transmitted), the proposed Method 1 is able to cross-RP/carrier indicate SL resources in up to 2 other RPs/carriers.

In another example (Method 2), at least one additional set of SL resources along with an associated SL carrier index or a RP index for the set is provided in the 1^{st} stage SCI or the 2^{nd} stage SCI for assigning/reserving of up to 3 SL resources in another RP/carrier. This means, a maximum of 3 SL resources can be indicated per RP/carrier and up to 2 RPs/carriers can be indicated per PSCCH/PSSCH transmission (total of up to 6 SL resources).

In one more example (Method 3), which is conceptually a combination of the above Method 1 and Method 2, a carrier index or RP index is indicated per assigned/reserved SL resource and per set of up to 3 SL resources. The first set of up to 3 SL resources along with a carrier index or a RP index per SL resource (except for the SL resource in which the SCI is transmitted) is indicated in the 1^{st} stage SCI. The additional set(s) of up to 3 SL resources along with their associated RP/carrier index(es) is indicated in the 1^{st} stage SCI or the 2^{nd} stage SCI. When only one additional set of up to 3 SL resources is provided, a maximum of 6 SL resources can be indicated across up to 6 different SL RPs/carriers per PSCCH/PSSCH transmission.

In the above examples (Method 1, 2 and 3), the carrier index(es) and/or the resource pool index(es) used in SCI is firstly provided to the UE by (pre-)configuration, by the higher layers, or by PC5-RRC signaling from another UE. For example, the carrier index(es) and/or the resource pool index(es) for SL broadcast transmissions are (pre-)configured to the UE since the broadcast transmission is intended for all UEs receiving the SCI. For SL groupcast transmissions, the group session and group members are established by the higher layers, hence, the carrier index(es) and/or the resource pool index(es) can be provided by the higher layers. For SL unicast transmissions, since the carriers and resource pools to be used can be negotiated between the two communicating UEs, the determination of carrier index(es) and/or resource pool index(es) can be signaled via PC5-RRC. In the above examples (Method 2 and 3), different sets of SL resources can be associated with different transport blocks (TBs) or the same TB.

FIG. 6 illustrates a proposed cross-carrier resource assignment/reservation indication in a SL multi-carrier operation according to an embodiment of the present disclosure. In the exemplary illustration in Diagram 200 of FIG. 6, an exemplary illustration of cross-RP/carrier indication of selected resources for assigning/reserving SL resources in another RP/carrier based on the proposed Method 1 is illustrated. For a UE configured to perform SL communication on more than one SL resource pool/carriers, the UE is firstly configured or indicated by the higher layer with a set of RPs/carriers comprising a RP_1 201 on SL carrier 1 and a RP_2 202 on SL carrier 2 for PSCCH/PSSCH transmissions. When a set of multiple SL resources 203, 205, and 206 are network scheduled or self-selected for the UE on more than one RP/carrier to transmit PSCCH/PSSCH for a single TB, a SCI 204 transmitted by the UE in the first scheduled/selected SL resource 203. This can provide a forward resource assignment/reservation of SL resources 205 and 206 for retransmissions of the single TB (besides the initial transmission in SL resource 203).

During transmission of the SCI 204, the UE indicates the RP/carrier index for the assigned/reserved SL resource 205 and the RP/carrier index for the assigned/reserved SL resource 206. For another UE_1 (e.g., a RedCap UE with limited RX capability) that is monitoring SCI only on the configured/indicated RP_1 201 on SL carrier 1, up on the reception of SCI 204, it may obtain the SL resource assignment/reservation for SL resource 205 on RP_2 202 (or RP/carrier 2) and also the SL resource assignment/reservation for SL resource 206 on RP_1 201 (or RP/carrier 1). Subsequently, once the reception of the SL transmission in SL resource 203 is completed, the another UE_1 switches its RX chain/circuitry to RP_2 202 on SL carrier 2 for the reception of PSCCH/PSSCH in SL resource 205 from the UE.

Similarly, the another UE_1 switches back to RP_1 201 on SL carrier 1 for the reception of PSCCH/PSSCH in SL resource 206 from the UE. During transmission of a SCI 207 from the UE, the UE indicates the RP/carrier index for the assigned/reserved SL resource 206. As such, the SL resource 206 is assigned/reserved twice by the same UE in both SCI 204 and SCI 207, hence, the reliability is provided if a reception UE has missed one of these two SCI transmissions. For yet another UE_2 that monitors SCI only on RP_2 202 on SL carrier 2, although it misses the first SL transmission of the single TB in SL resource 203, based on reception of SCI 207, the another UE_2 would still be able to receive the same single TB transmitted in SL resources 205 and 206.

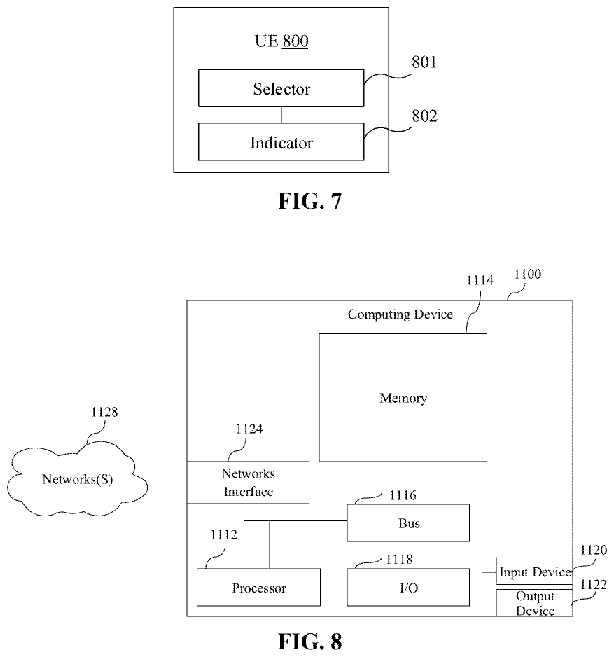

FIG. 7 illustrates a UE 800 for wireless communication according to an embodiment of the present disclosure. The UE 800 includes a selector 801 and an indicator 802. The selector 801 is configured to select SL resources for SL transmission across multiple resource pools (RPs)/carriers, wherein the multiple RPs/carriers include a first RP on a first SL carrier and a second RP on a second SL carrier. The indicator 802 is configured to indicate selected SL resources across the multiple RPs/carriers for assignment and reservation during the SL transmission. This can solve issues in the prior art and other others, and/or improve SL communication performance and reliability.

In some embodiments, the selector 801 is configured to sense on one or more RPs and/or carriers over a common sensing window to obtain sensing results, wherein selecting the SL resources for SL transmission across the multiple RPs/carriers is based on the sensing results. In some embodiments, the one or more RPs and/or carriers is one, a subset, or a full set of the multiple SL RPs/carriers, or the one or more RPs and/or carriers is the multiple RPs/carriers. In some embodiments, the selector 801 is configured to exclude or avoid selecting overlapping candidate resources from the multiple RPs/carriers based on the sensing results. In some embodiments, the selector 801 is configured to trigger a UE autonomous resource allocation by providing one or more parameters to a first layer of the UE for reporting a subset of candidate resources per RP/carrier to the at least one higher layer after excluding or avoiding selecting the overlapping candidate resources. In some embodiments, excluding or avoiding selecting the overlapping candidate resources is based on a SL reference signal received power (SL-RSRP) and/or a SL-RSRP threshold level.

In some embodiments, the SL-RSRP and/or the SL-RSRP threshold level is determined based on a priority level of the SL transmission and/or a priority level in a sidelink control information (SCI). In some embodiments, excluding or avoiding selecting the overlapping candidate resources is based on a limitation of number of simultaneous transmissions supported by the UE over the multiple carriers/RPs. In some embodiments, excluding or avoiding selecting the overlapping candidate resources is based on one or more carrier combinations and/or an interruption due to radio frequency (RF) retuning time. In some embodiments, excluding or avoiding selecting the overlapping candidate resources is based on a physical sidelink feedback channel (PSFCH) reception timing/slot. In some embodiments, for reporting the subset of candidate resources per RP/carrier to the at least one higher layer, if a remaining number of candidate resources for one RP/carrier is less than a first percentage of a full set of candidate resources for the one RP/carrier, the SL-RSRP threshold level is increased by a first value for each priority level, and excluding or avoiding selecting the overlapping candidate resources is re-performed from the full set of candidate resources for the one RP/carrier.

In some embodiments, for reporting the subset of candidate resources per RP/carrier to the at least one higher layer, if remaining candidate resources across the multiple RPs/carriers is less than a first percentage of a combined number of a full set of candidate resources of each RP/carrier, the SL-RSRP threshold level is increased by a first value for each priority level, and excluding or avoiding selecting the overlapping candidate resources is re-performed from the full set of candidate resources for every RP/carrier. In some embodiments, selecting the SL resources for SL transmission across the multiple RPs/carriers includes selecting, by the at least one higher layer of the UE, the SL resources for SL transmission from the reported candidate resource sets of the multiple RPs/carriers based on a time gap not more than 31 slots between any two or three consecutive selected resources. In some embodiments, a time gap between two selected consecutive resources on the same RP/carrier is more than 31 slots if a cross-RP/carrier resource assignment/reservation is allowed for the UE and/or intended by the UE. In some embodiments, if one RP/carrier is configured with PSFCH resources, a minimum time gap is between any two consecutive selected resources within the one RP/carrier.

In some embodiments, indicating the selected SL resources across the multiple RPs/carriers for assignment and reservation during the SL transmission includes: a carrier index and/or a RP index is provided per SL resource indicated in frequency and time resource assignment fields of a first stage SCI. In some embodiments, indicating the selected SL resources across the multiple RPs/carriers for assignment and reservation during the SL transmission includes at least one additional set of SL resources along with a carrier index and/or a RP index is provided in the first stage SCI or a second stage SCI for assigning/reserving SL resources in another RP/carrier. In some embodiments, indicating the selected SL resources across the multiple RPs/carriers for assignment and reservation during the SL transmission includes a carrier index and/or a RP index is indicated per assigned/reserved SL resource and per set of up to 3 SL resources. In some embodiments, a first set of up to 3 SL resources along with a carrier index and/or a RP index per SL resource is indicated in the first stage SCI.

In some embodiments, at least one additional set of SL resources along with a carrier index and/or a RP index is indicated in the first stage SCI or the second stage SCI. In some embodiments, the carrier index and/or the RP index is provided to the UE by a network configuration or a pre-configuration, at least one higher layer, or a PC5 radio resource control (PC5-RRC) signaling from another UE. In some embodiments, the carrier index and/or the RP index for SL broadcast transmission is provided to the UE by the network configuration or the pre-configuration, the carrier index and/or the RP index for SL groupcast transmission is provided to the UE by the at least one higher layer, or the carrier index and/or the RP index for SL unicast transmission is provided to the UE by the network configuration or the pre-configuration. In some embodiments, different sets of SL resources are associated with different transport blocks (TBs) or the same TB.

In summary, in order to help and support sidelink UE with limited/reduced transmission and reception capability to operate and communicate efficiently and reliably with other SL UEs with full or limited/reduced capability, in some exemplary SL resource allocation and indication methods, it is proposed to jointly select SL resources for transmission across multiple RPs/carriers and cross-RP/carrier indicate the selected SL resources for assignment and reservation during the transmission. In some embodiments, for a UE jointly selects resources from a set of configured/indicated multiple SL RPs/carriers based on sensing results obtained from one, a subset or the full set of the SL RPs/carriers, a higher layer triggers a UE autonomous resource allocation procedure by providing one or more of parameters (illustrated in the above some embodiments) to L1 for reporting a subset of candidate resources per configured/indicated SL RP/carrier after a resource exclusion process. In some embodiments, for a UE jointly indicates selected resources across more than one RP/carrier for assignment and reservation during a SCI transmission, one or a combination of the following cross-RP/carrier resource indication methods could be used.

Other benefits from using the proposed exemplary resource allocation and indication methods also include at least one of the followings: 1. Reduce a transmission collision probability based on a cross-RP/carrier indication. 2. Avoid a resource selection conflict within a UE for already selected resources and potential transmissions. 3. Avoid dropping of SL transmissions due to a required RF retuning time for inter-band multi-carrier SL operation. 4. Avoid mis-detection of physical sidelink feedback channel (PSFCH) feedback transmissions due to limited reception capability of the UE. 5. In some scenarios, some exemplary methods create more indications/reservation for a selected resource, and thus can improve/minimize the half-duplex problem when another UE transmits and cannot receive one of the indications. 6. In some scenarios, some exemplary methods reduce processing power consumption for a SL CA receiver UE to monitor SCI in one RP/carrier only. 7. Reduced SCI signaling in RPs configured with no physical sidelink control channel (PSCCH) resources would provide more frequency resources for the actual data transmission for improved performance and higher data rate. 8. Reduced SCI signaling also means less SCI monitoring for the receiver UEs, especially for SL RedCap UEs to improve/minimize processing power in both RF and baseband. 9. In some cases, the cross-RP/carrier resource assignment/reservation indication improves the reliability of SL transmissions in a fast fading channel when one of carrier is in a deep fade condition.

Commercial interests for some embodiments are as follows. 1. Solving issues in the prior art and other issues. 2. Improving a sidelink (SL) communication performance. 3. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, and beyond for providing direct device-to-device (D2D) wireless communication services.

FIG. 8 is a block diagram of an example of a computing device according to an embodiment of the present disclosure. Any suitable computing device can be used for performing the operations described herein. For example, FIG. 8 illustrates an example of the computing device 1100 that can implement some embodiments in FIG. 1 to FIG. 7, using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C #, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to FIG. 1 to FIG. 7. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

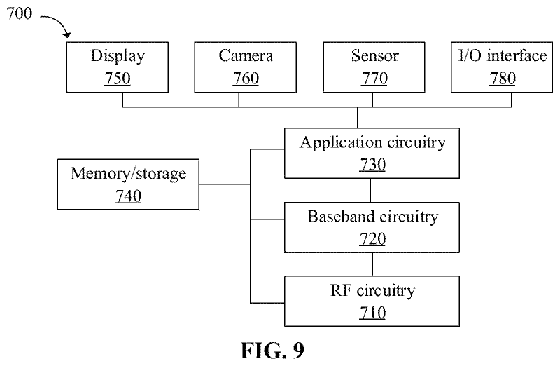

FIG. 9 is a block diagram of an example system 700 for wireless communication according to an embodiment of the present disclosure. Embodiments described herein may be implemented into the system using any suitably configured hardware and/or software. FIG. 9 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

In the embodiments of the disclosure, the term “and/or” merely indicates an association relationship for describing associated objects, and represents that there are three kinds of relationships. For example, “A and/or B” may represent three situations, i.e., independent existence of A, existence of both A and B, and independent existence of B. In addition, in this context, the character “/” generally indicates that the anterior and posterior associated objects are in a kind of “or” relationship.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for resource allocation and indication in sidelink (SL) communication by a user equipment (UE), comprising:
selecting, by the UE, SL resources for SL transmission across multiple resource pools (RPs)/carriers, wherein the multiple RPs/carriers comprise a first RP on a first SL carrier and a second RP on a second SL carrier; and
indicating, by the UE, selected SL resources across the multiple RPs/carriers for assignment and reservation during the SL transmission.

2. The method of claim 1, further comprising:
performing sensing, by the UE, on one or more RPs and/or carriers over a common sensing window to obtain sensing results, wherein selecting the SL resources for SL transmission across the multiple RPs/carriers is based on the sensing results.

3. The method of claim 2, wherein the one or more RPs and/or carriers is one, a subset, or a full set of the multiple SL RPs/carriers, or the one or more RPs and/or carriers is the multiple RPs/carriers.

4. The method of claim 2, further comprising:
excluding or avoiding selecting, by the UE, overlapping candidate resources from the multiple RPs/carriers based on the sensing results.

5. The method of claim 4, further comprising:
triggering, by at least one higher layer of the UE, a UE autonomous resource allocation by providing one or more parameters to a first layer of the UE for reporting a subset of candidate resources per RP/carrier to the at least one higher layer after excluding or avoiding selecting the overlapping candidate resources.

6. The method of claim 4, wherein excluding or avoiding selecting the overlapping candidate resources is based on a SL reference signal received power (SL-RSRP) and/or a SL-RSRP threshold level,
wherein the SL-RSRP and/or the SL-RSRP threshold level is determined based on a priority level of the SL transmission and/or a priority level in a sidelink control information (SCI).

7. The method of claim 4, wherein at least one of the following applies:
excluding or avoiding selecting the overlapping candidate resources is based on a limitation of number of simultaneous transmissions supported by the UE over the multiple carriers/RPs,
excluding or avoiding selecting the overlapping candidate resources is based on one or more carrier combinations and/or an interruption due to radio frequency (RF) retuning time, or
excluding or avoiding selecting the overlapping candidate resources is based on a physical sidelink feedback channel (PSFCH) reception timing/slot.

8. The method of claim 5, wherein for reporting the subset of candidate resources per RP/carrier to the at least one higher layer, if a remaining number of candidate resources for one RP/carrier is less than a first percentage of a full set of candidate resources for the one RP/carrier, the SL-RSRP threshold level is increased by a first value for each priority level, and excluding or avoiding selecting the overlapping candidate resources is re-performed from the full set of candidate resources for the one RP/carrier.

9. The method of claim 5, wherein for reporting the subset of candidate resources per RP/carrier to the at least one higher layer, if remaining candidate resources across the multiple RPs/carriers is less than a first percentage of a combined number of a full set of candidate resources of each RP/carrier, the SL-RSRP threshold level is increased by a first value for each priority level, and excluding or avoiding selecting the overlapping candidate resources is re-performed from the full set of candidate resources for every RP/carrier.

10. A user equipment (UE), comprising a memory and a processor, the memory storing a computer program that, when executed by the processor, causes the processor to perform a method for resource allocation and indication in sidelink (SL) communication, the method comprising:
selecting SL resources for SL transmission across multiple resource pools (RPs)/carriers, wherein the multiple RPs/carriers comprise a first RP on a first SL carrier and a second RP on a second SL carrier; and
indicating selected SL resources across the multiple RPs/carriers for assignment and reservation during the SL transmission.

11. The UE of claim 10, wherein selecting the SL resources for SL transmission across the multiple RPs/carriers comprises:
selecting, by at least one higher layer of the UE, the SL resources for SL transmission from the reported candidate resource sets of the multiple RPs/carriers based on a time gap not more than 31 slots between any two or three consecutive selected resources.

12. The UE of claim 11, wherein a time gap between two selected consecutive resources on the same RP/carrier is more than 31 slots if a cross-RP/carrier resource assignment/reservation is allowed for the UE and/or intended by the UE.

13. The UE of claim 11, wherein if one RP/carrier is configured with PSFCH resources, a minimum time gap is between any two consecutive selected resources within the one RP/carrier.

14. The UE of claim 10, wherein indicating the selected SL resources across the multiple RPs/carriers for assignment and reservation during the SL transmission comprises:
a carrier index and/or a RP index is provided per SL resource indicated in frequency and time resource assignment fields of a first stage SCI.

15. The UE of claim 10, wherein indicating the selected SL resources across the multiple RPs/carriers for assignment and reservation during the SL transmission comprises:
at least one additional set of SL resources along with a carrier index and/or a RP index is provided in the first stage SCI or a second stage SCI for assigning/reserving SL resources in another RP/carrier.

16. The UE of claim 10, wherein indicating the selected SL resources across the multiple RPs/carriers for assignment and reservation during the SL transmission comprises:
a carrier index and/or a RP index is indicated per assigned/reserved SL resource and per set of up to 3 SL resources.

17. The UE of claim 16, wherein at least one of the following applies:
a first set of up to 3 SL resources along with a carrier index and/or a RP index per SL resource is indicated in the first stage SCI; or
at least one additional set of SL resources along with a carrier index and/or a RP index is indicated in the first stage SCI or the second stage SCI.

18. The UE of claim 14, wherein the carrier index and/or the RP index is provided to the UE by a network configuration or a pre-configuration, at least one higher layer, or a PC5 radio resource control (PC5-RRC) signaling from another UE, and
wherein the carrier index and/or the RP index for SL broadcast transmission is provided to the UE by the network configuration or the pre-configuration, the carrier index and/or the RP index for SL groupcast transmission is provided to the UE by the at least one higher layer, or the carrier index and/or the RP index for SL unicast transmission is provided to the UE by the network configuration or the pre-configuration.

19. The UE of claim 14, wherein different sets of SL resources are associated with different transport blocks (TBs) or the same TB.

20. A chip, comprising:
a processor, configured to call and run a computer program stored in a memory, to cause a device in which the chip is installed to:
select SL resources for SL transmission across multiple resource pools (RPs)/carriers, wherein the multiple RPs/carriers comprise a first RP on a first SL carrier and a second RP on a second SL carrier; and
indicate selected SL resources across the multiple RPs/carriers for assignment and reservation during the SL transmission.
